(19) United States
(12) Patent Application Publication
(10) Pub. No.: US 2013/0159610 A1
(43) Pub. Date: Jun. 20, 2013

(54) NON-VOLATILE SEMICONDUCTOR MEMORY DEVICE RELATED METHOD OF OPERATION

(71) Applicant: SAMSUNG ELECTRONICS CO., LTD., Suwon-si (KR)

(72) Inventor: Shoichi Kawamura, Yokohama-shi (JP)

(73) Assignee: SAMSUNG ELECTRONICS CO., LTD., SUWON-SI (KR)

(21) Appl. No.: 13/711,881

(22) Filed: Dec. 12, 2012

(30) Foreign Application Priority Data
Dec. 16, 2011 (JP) 2011-275700
Nov. 5, 2012 (KR) 10-2012-0124144

(51) Int. Cl. G06F 12/02

(52) U.S. Cl. CPC G06F 12/0246
USPC 711/103

(57) ABSTRACT

A non-volatile semiconductor memory device includes a flash memory including plural blocks of memory cells, and a controller. The controller is configured to program a block of memory cells of the flash memory, to determine a first time period elapsed in which a given percentage of memory cells of the block of memory cells are programmed, and to compare the first time period with a reference second time period. The flash memory and controller are further configured, based on a comparison result between the first time period and the reference time period, to change an operational parameter associated with the block of memory cells, the changed operational parameter being in effect during at a next operational access of the block of memory cells.

### CROSS-REFERENCE TO RELATED APPLICATIONS

A claim for priority under 35 U.S.C. §119 is made to Japan Patent Application No. 2011-275700 filed Dec. 16, 2011, in the Japan Intellectual Property Office, and to Korean Patent Application No. 10-2012-0124144 filed Nov. 5, 2012, in the Korean Intellectual Property Office, the entire contents of both of which are hereby incorporated by reference.

### BACKGROUND

The inventive concepts described herein relate to non-volatile semiconductor memory devices including flash memory, and to the operational control of such non-volatile semiconductor memory devices.

In a flash memory, such as a NAND flash memory, an oxide film of a memory cell may be deteriorated due to iteration of program-erase cycles. In this case, charges may be trapped by the oxide film, so that a distribution of minimum threshold voltages causing reaction of programmed cells is widened. For example, FIG. 10 is a diagram illustrating a distribution of minimum threshold voltages Vt causing reaction of single level cells. FIG. 10(I) shows a distribution of minimum threshold voltages Vt causing reaction before cycling. FIG. 10(II) shows a distribution of minimum threshold voltages Vt causing reaction after cycling. In these figures, a voltage Vpgmv denotes a voltage that may be applied to a word line at a program verify operation, a voltage Vread denotes a voltage that may be applied to an unselected word line at a read operation. As illustrated, in comparison with a distribution before cycling, an after-cycling distribution of minimum threshold voltages Vt causing reaction of memory cells may be widened.

Widening of the distribution of minimum threshold voltages Vt can adversely impact device reliability, and thus a number of efforts have been made to combat this characteristic of flash memory.

Japanese (JP) Patent No. 3946849 discloses a non-volatile semiconductor memory device configured to optimize an erase operation in accordance with a number of write and erase operations of the device. The intention is to avoid an increase in an erase time as an erase number increases. The non-volatile semiconductor memory device may store the number of erase operations executed in an erase number storing part, and a read time may be determined according to the erase number by controlling a read time of a read time establishing circuit.

JP Publication No. 2005-122800 provides a non-volatile semiconductor memory device includes a function which manages a data erase number of each of sub-blocks. In this non-volatile semiconductor memory device, a data erase number may be stored whenever each sub-block of a cell array is erased by the sub-block. A data erase number of each sub-block may be limited according to an allowable maximum value of a data erase number which is stored in a predetermined block of the cell array.

JP National Publication No. 2003-532222 describes determining whether a wear level of the first block is allowable when a first block is to be erased. If the wear level of the first block is allowable, data of the first block may be erased. If not, there may be selected a second block having a wear level lower than that of the first block, and data of the second block may be copied to the first block. Each block may have a counter associated with monitoring of an erase number.

JP Publication No 2002-32256 describes a terminal device configured to distribute an update frequency all over a NAND flash memory by preventing an update from being focused on a specific area of the NAND flash memory. The terminal device may be capable of improving a processing speed associated with a data updating operation of a product by reducing an update number of a block during update execution.

JP Publication No. 2000-163976 describes a multi-level non-volatile semiconductor memory device capable of reducing an overall data write time by reducing unnecessary verify operations.

### SUMMARY

According to an aspect of one or more embodiments of the inventive concept, a non-volatile semiconductor memory device which includes a flash memory including plural blocks of memory cells, and a controller. The controller is configured to program a block of memory cells of the flash memory, to determine a first time period elapsed in which a given percentage of memory cells of the block of memory cells are programmed, and to compare the first time period with a reference second time period. The flash memory and controller are further configured, based on a comparison result between the first time period and the reference time period, to change an operational parameter associated with the block of memory cells, the changed operational parameter being in effect during at a next operational access of the block of memory cells.

According to another aspect of one or more embodiments of the inventive concept, a method of operating a non-volatile semiconductor memory device is provided, where the non-volatile semiconductor memory device includes a memory controller and a flash memory including plural blocks of memory cells. The method includes programming a block of memory cells of the flash memory, determining a first time period elapsed in which a given percentage of memory cells of the block of memory cells are programmed, and comparing the first time period with a reference second time period. The method further includes, based on a comparison result between the first time period and the reference time period, changing an operational parameter associated with the block of memory cells, the changed operational parameter being in effect during at a next operational access of the block of memory cells.

### BRIEF DESCRIPTION OF THE FIGURES

The above and other objects and features will become apparent from the description that follows with reference to the accompanying figures, wherein like reference numerals refer to like parts throughout the various figures unless otherwise specified.

FIG. 1 is a block diagram schematically illustrating a non-volatile semiconductor memory device according to an embodiment of the inventive concept.

FIG. 2 is a block diagram schematically illustrating a NAND flash memory of FIG. 1.

FIG. 3 is a diagram schematically illustrating a memory cell array.

FIG. 4 is a diagram illustrating variations in a program time, an N % pass time, and an erase time according to the number of cycling.

FIG. 5 is a diagram illustrating a variation in a time period tPROG_Majority and a change of an operational parameter of flash memory.

FIG. 6 is a diagram illustrating a condition table according to an embodiment of the inventive concept.

FIG. 7 is a flow chart illustrating an operation of a non-volatile semiconductor memory device according to an embodiment of the inventive concept.

FIG. 8 is a block diagram schematically illustrating a non-volatile semiconductor memory device according to another embodiment of the inventive concept.

FIG. 9 is a block diagram schematically illustrating a NAND flash memory according to another embodiment of the inventive concept.

FIG. 10 is a diagram illustrating a distribution of minimum threshold voltages causing reaction of single level cells.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section.

Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

As is traditional in the field of the inventive concept, embodiments may be described in the context of functional blocks or units. It will be understood that these blocks or units may be physically implemented by hardware, software and/or a combination of hardware and software. It will be further understood that these block or units may be combined into more complex blocks or units.

According to an aspect of a non-volatile semiconductor memory device of the inventive concept, a program time (as opposed to a cycling number) of each memory block of a flash memory is monitored. The memory block may be a unit block of a flash memory cell array that is accessed (or, programmed). When the program time is determined to be less than a reference value, a corresponding block address may be stored. When the block is accessed next, an operational parameter of a flash memory may be changed to thereby alter an operational condition of the block of flash memory.

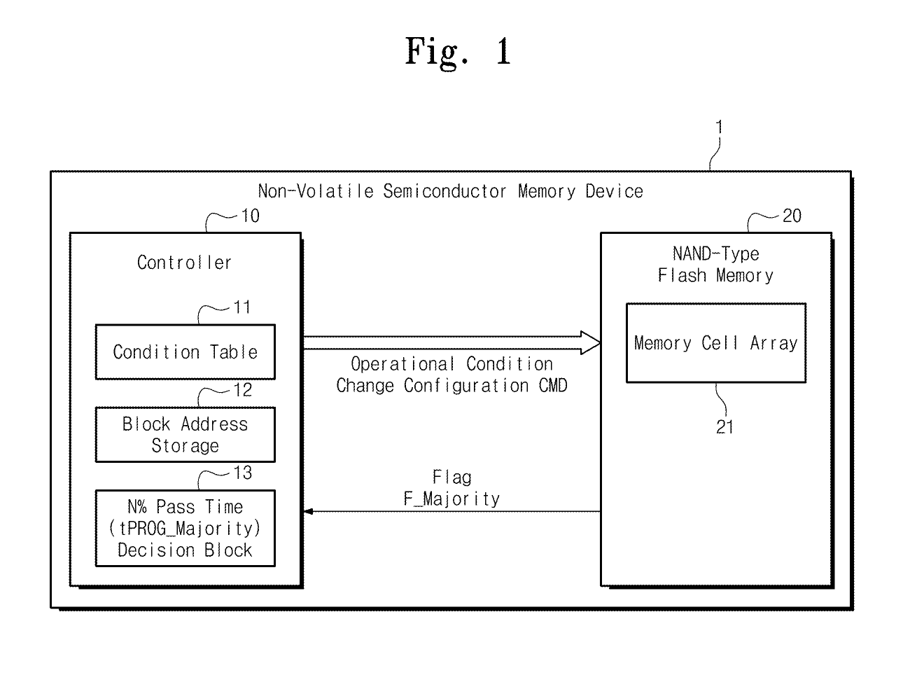

FIG. 1 is a block diagram schematically illustrating a non-volatile semiconductor memory device according to an embodiment of the inventive concept. The non-volatile semiconductor memory device 1 illustrated in the example of FIG. 1 includes flash memory (in this example, NAND flash memory). FIG. 1 illustrates components associated with the embodiment of the inventive concept, and it will be understood that the device 1 may include other components not shown.

Referring to FIG. 1, the non-volatile semiconductor memory device 1 includes a NAND flash memory 20 and a controller 10. The NAND flash memory 20 of this example includes a memory cell array 21 in which memory cells are arranged in an array.

The controller 10 generates various commands (program command, read command, etc.) with respect to a block of the NAND flash memory 20, where the block constitutes a unit of the memory cell array 21 that may be accessed during execution of each command.

In addition, according to the present embodiment, the controller 10 generates what is referred to here as an operational condition change configuration command. The command CMD is for configuring an operational parameter of the NAND flash memory 20. That is, as will be explained in detail later herein, the NAND flash memory 20 is responsive to the operational condition change configuration command to configure an operational parameter of the NAND flash memory 20. Non-limiting examples of the operational parameter include a program voltage and a read voltage.

The NAND flash memory 20 of the example of this embodiment is configured to generate a flag signal F_Majority to the controller 10 at a time when a given percentage N % (where 0<N≦100) of memory cells of an accessed block are successfully programmed.

Still referring to FIG. 1, the controller 10 of the example of this embodiment includes a condition table 11, a block address storage 12, and an N % pass time decision block 13.

The N % pass time decision block 13 of the controller 10 determines a time period tPROG_Majority based on generation of the flag signal F_Majority from the NAND flash memory 20. For example, the time period tPROG_Majority may be the time elapsed from the start of programming (e.g., issuing of a program command) a target block to a time at which the flag signal F_Majority is generated. The N % pass time decision block 13 may also determine whether the time period tPROG_Majority is less than a predetermined reference value (e.g., 150 μs), and if so, a number (corresponding to a correction number) by which the time period tPROG_Majority is less than a predetermined reference value.

When the time period tPROG_Majority is determined to be less than the predetermined reference value (e.g., 150 μs), a corresponding block address of a block address storage block 12 may store the number (correction number) by which the time period tPROG_Majority of a corresponding block is determined to be below the reference value.

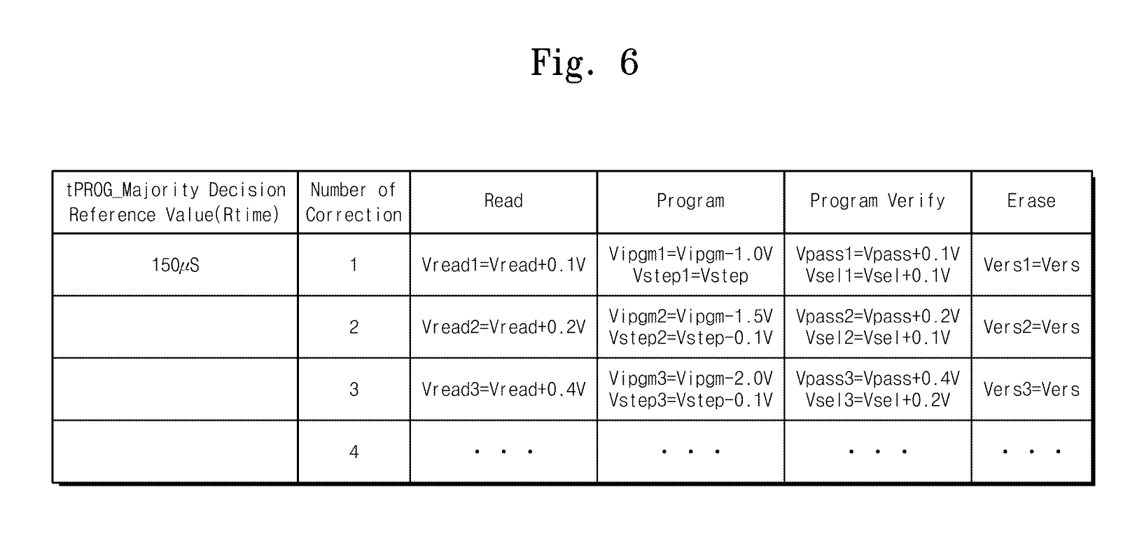

In the non-volatile semiconductor memory device 1, when a block of the NAND flash memory 20 is accessed, the controller 10 may first refer to the block address storage block 12 and a condition table 11. Here, the condition table 11 may be used to store a reference value of the time period tPROG_Majority, the number (correction number) by which the time period tPROG_Majority of a corresponding block is determined to be below the reference value, and an operational condition (i.e., operational parameter) of the NAND flash memory to be applied to a block from a next access according to the number (correction number) (refer to FIG. 6).

In the case where a block address of a block to be accessed is stored at the block address storage block 12, the controller 10 may read a correction number and an operational condition corresponding thereto. The controller 10 may configure the NAND flash memory 20 with the operational condition read from the condition table 11, and then may perform an operation (a read/program/erase operation).

The NAND flash memory 20 changes an operational condition in response to an operational condition change configuration command from the controller 10. As an example of the operational condition, the NAND flash memory 20 may change (or, decrease) a start voltage Vipgm of a program stress. Also, for example, the NAND flash memory 20 may change (or, decrease) a voltage step Vstep in an incremental step pulse programming (ISPP) cycle in which a program operation is executed over increasing a gate voltage of a memory cell by a constant voltage Vstep. In this case, a program speed of the NAND flash memory 20 may be suppressed, so that over-programming is prevented.

Alternatively, the NAND flash memory 20 may change (or, increase) a voltage Vread of an unselected word line at a read operation. In this case, although a memory cell is over-programmed, the flash memory 20 may have a read margin for reading data normally when data is read from the memory cell. Alternatively, the NAND flash memory 20 may change (or, increase) a voltage Vsel of a selected word line at a program verify operation. While it is relatively easy to program a memory cell at iteration of cycling, charge storing and retaining characteristics may be deteriorated. Thus, the NAND flash memory 20 may have a margin for reading data normally by changing (or, increasing) the voltage Vsel applied to a selected word line at the program verify operation.

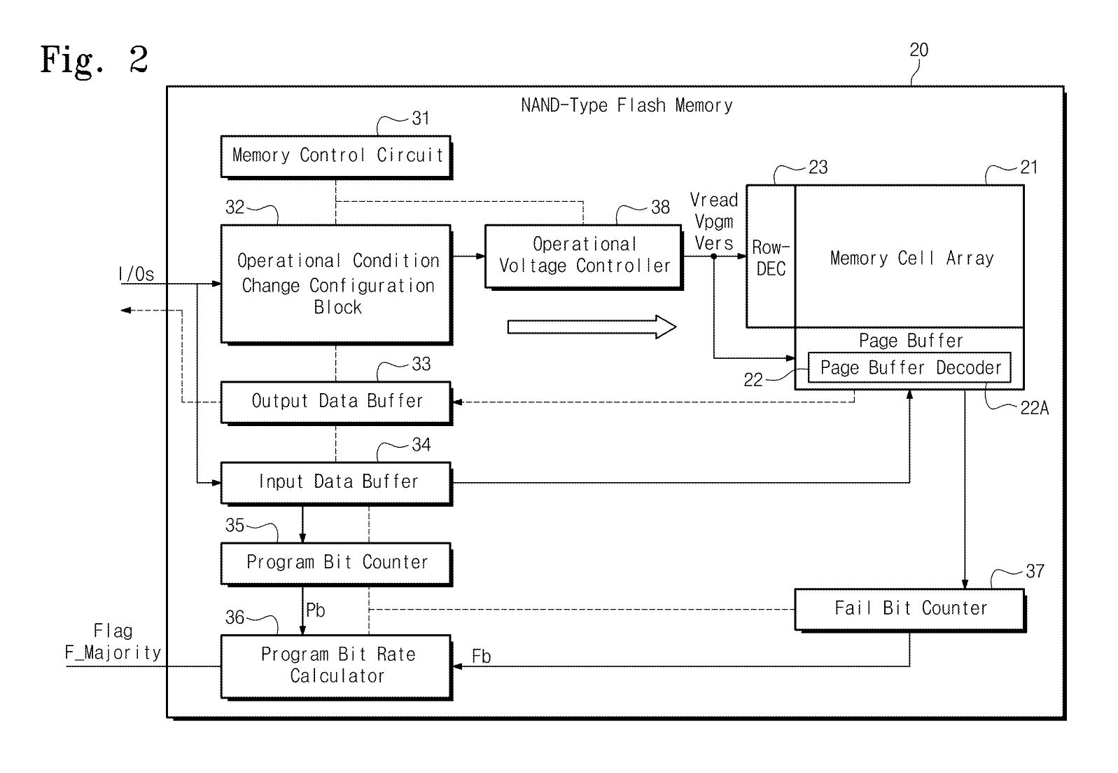

FIG. 2 is a block diagram schematically illustrating an embodiment of a NAND flash memory of FIG. 1. FIG. 2 shows a configuration associated with the inventive concept. Referring to FIG. 2, a NAND flash memory 20 may include a memory cell array 21, a page buffer 22 having a page buffer decoder 22A, and a row decoder 23. The NAND flash memory may further include a memory control circuit 31 to control an overall operation of the NAND flash memory 20, an operational condition change configuration block 32, an output data buffer 33, an input data buffer 34, a program bit counter 35, a program bit rate calculator 36, a fail bit counter 37, and an operational voltage controller 38.

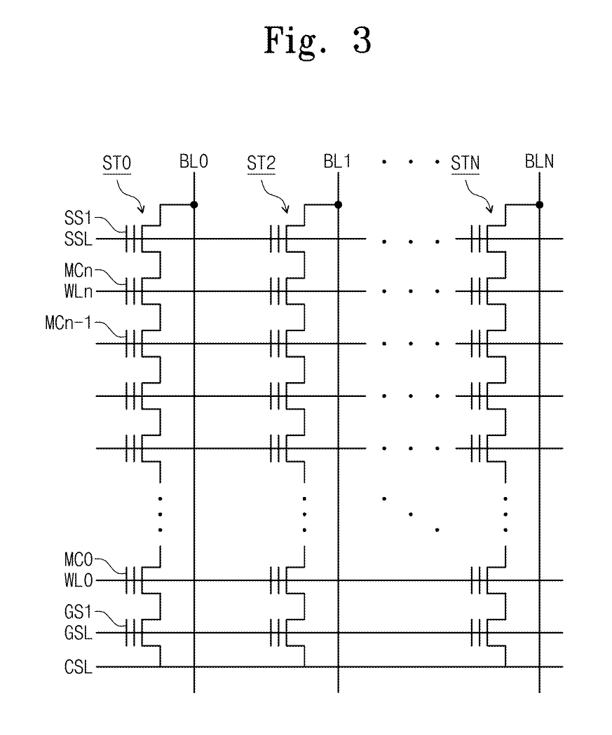

In the NAND flash memory 20, the memory cell array 21 may include a plurality of memory blocks such as a memory block illustrated in FIG. 3. Each block, as illustrated in FIG. 3, may include (N+1) bit lines BL0 to BLN (hereinafter, referred to as BL), (n+1) word lines WL0 to WLn (hereinafter, referred to as WL), a common source line CSL, and (N+1) memory strings ST0 to STN (hereinafter, referred to as ST) each connected between a corresponding bit line and the common source line CSL. Each memory string ST may include electrically erasable and programmable non-volatile memory cells MC0 to MCn connected in series and having a structure of (n+1) floating gates. In each memory string ST, a memory cell MCn of a drain side may be connected to a corresponding bit line BL by a selection gate transistor SS1, and a memory cell MC0 of a source side may be connected to the common source line CSL through a selection gate transistor GS1. Control gates of memory cells in the same row may be connected to a common word line WL.

In the block illustrated in FIG. 3, a memory cell may be erased by applying a high voltage to a semiconductor substrate and 0V to the word lines WL0 to WLn, for example. At this time, electron may be discharged from a floating gate being a charge storage layer formed of a poly silicon material, so that a minimum threshold voltage causing a reaction of a memory cell MC is set to a minimum threshold voltage VtL (e.g., −1V) causing an erase reaction. As an example of a program operation, electron may be injected into the floating gate by applying 0V to a source and a drain and a high voltage to a control gate (selected word line). In this case, a minimum threshold voltage causing a reaction may increase to be set to a minimum threshold voltage VtH causing a write reaction. In the case where a minimum threshold voltage causing reactions of memory cells MC0 to MCn is a minimum threshold voltage VtL, a data value of a corresponding memory cell may be ‘1’. In the case where a minimum threshold voltage causing reactions of memory cells MC0 to MCn is a minimum threshold voltage VtH, a data value of a corresponding memory cell may be ‘0’.

When data is read out from memory cells, all bit lines BL may be pre-charged to a predetermined voltage. Afterwards, a read voltage between VtL and VtH may be applied to a word line WL connected in common to memory cells MC to be read. The remaining memory cells MC excepting the selected memory cells and control gates of the selection gate transistors SS1 and GS1 may be biased such that the remaining memory cells MC excepting the selected memory cells and the selection gate transistors SS1 and GS1 are turned on. Thus, when a data value of a selected memory cell is ‘1’, a cell current may flow through the selected memory cell. When a data value of a selected memory cell is ‘0’, no cell current may flow through the selected memory cell. Data written at a memory cell may be read based on whether a cell current flows or not.

In the NAND flash memory 20 of FIG. 2, the operational condition change configuration block 32 may configure an operational condition (i.e., operational parameter) of the NAND flash memory 20 as indicated by an operational condition change configuration command provided from the controller 10. The output data buffer 33 may be a buffer circuit for external output of data read from the memory cell array 21. The output data buffer 33 may output data onto data input/output lines I/Os being connection lines with an external device. The input data buffer 34 may be connected with the data input/output lines I/Os, and may be a buffer circuit used to receive data, an address signal, and an operational control command from the external device. The program bit counter 35 may detect a bit number (a total of write bits) of memory cells to be programmed in a program target block, and may provide information indicative of a program bit number to the program bit rate calculator 36.

At a verify read operation, the fail bit counter 37 may count the number of memory cells determined as fail cells, and may output information indicative of the number of fail cells to the program bit rate calculator 36. The program bit rate calculator 36 may calculate a program bit rate (%) according to the following formula 1 based on the information indicative of the program bit number Pb from the program bit counter 35 and the information indicative of the number of fail bits from the fail bit counter 37. Further, a pass bit rate may be a value indicative of a rate of memory cells program passed (program verify passed) in a programmed block. Also, a program bit rate (%) may be named an N % ratio.

Program bit rate(N % ratio)=(Pb−Fb)×100/Pb (1)

The program bit rate calculator 36 may output a flag F_Majority to a controller 10 when the program bit rate (a ratio of memory cells passing program verification) exceeds a predetermined ratio (e.g., 70%).

The operational voltage controller 38 may generate a boosted high voltage or an intermediate voltage to be used at operations such as a program operation, an erase operation, a read operation, etc. Voltage signals Vread, Vpgm, Vers, etc. generated by the operational voltage controller 38 may be output to the row decoder 23 and the page buffer 22. The operational voltage controller 38 may generate the voltage signals based on control command output from the memory control circuit 31 to perform a read operation, a program operation, and an erase operation and the operational condition change configuration block 32.

As described above, in the NAND flash memory 20, charges may be trapped by an oxide film of a memory cell due to iteration of cycling, so that a program time of the memory cell becomes fast (or, it is relatively easy to program the memory cell). However, in the case where a plurality of bits is simultaneously programmed at memory cells in the NAND flash memory 20, one or more bits having a slow program speed or a long program time may surely exist at the plurality of bits. Thus, it is difficult to know a program time using a total program time tPROG indicative of a sum of program times of the plurality of bits.

Further, the number of program fail bits may be counted to prevent program times of the majority of memory cells from being unknown due to one or more bits each having a slow program speed. A function of outputting a flag F_Majority to an external device may be provided when N % (N being any number of 1˜100) of memory cells is programmed with respect to a total of program bits. Also, the NAND flash memory 20 may change an operational condition in response to a request from an external device.

The non-volatile semiconductor memory device 1 may monitor a flag F_Majority output when N % of memory cells in a program target block is passed at program verification. The non-volatile semiconductor memory device 1 may determine a time period tPROG_Majority (a time period elapsed from a program start until a time when the flag F_Majority is output) according to the monitoring result.

When the N % pass time period tPROG_Majority of the program target block is below a reference value (e.g., 150 μs), the non-volatile semiconductor memory device 1 may store a block address of the program target block and the number by which the time period tPROG_Majority of the program target block is determined to be below the reference time, at the block address storage block 12. In the case where an access to the block address is performed later, the NAND flash memory 20 may be requested to apply a new operational condition referring to a condition table 11 on the basis of a correction number.

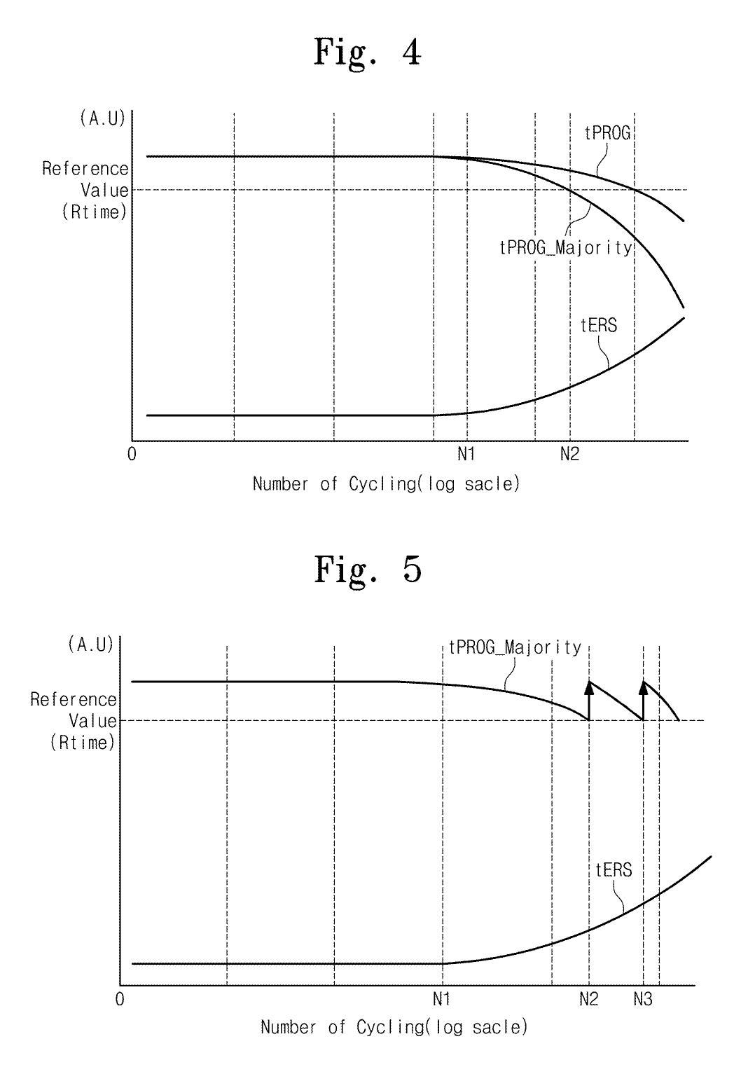

FIG. 4 is a diagram illustrating variations in a program time tPROG, an N % pass time period tPROG_Majority, and an erase time tERS according to the number of cycling. In FIG. 4, a horizontal axis may indicate the number of cycling (log scale), and a vertical axis may indicate a time. In addition, a time of the vertical axis may be any unit A.U. corresponding to a characteristic curve of each of tPROG, tPROG_Majority, and tERS.

Referring to FIG. 4, a program time tPROG, a time period tPROG_Majority, and an erase time tERS may be constant between a cycling number 0 and a cycling number N1. After a cycling number N1, charges may be trapped by an oxide film of a memory cell in a flash memory 20 due to iteration of cycling, so that a program time tPROG of the memory cell is shortened (it is relatively easy to program the memory cell). In other words, the erase time tERS may become longer. The time period tPROG_Majority from a program start unit a time when a flag F_Majority is output may become shorter.

When the shortened time period tPROG_Majority is below a reference value (time) Rtime (when a cycling number is 2), a controller 10 may generate a command to change an operational condition of a NAND flash memory 20. This will be more fully described. The time period tPROG_Majority may be recovered up to an original time (a time period tPROG_Majority before a cycling number N1) by changing an operational condition of the NAND flash memory 20.

FIG. 5 is a diagram illustrating a variation in a time period tPROG_Majority and a change of an operational condition of flash memory. In FIG. 5, a horizontal axis may indicate the number of cycling (log scale), and a vertical axis may indicate a time (A.U.). Referring to FIG. 5, a program time tPROG, an N % pass time period tPROG_Majority, and an erase time tERS may be constant between a cycling number 0 and a cycling number N1. After a cycling number N1, charges may be trapped by an oxide film of a memory cell in a flash memory 20 due to iteration of cycling, so that a program time tPROG of the memory cell is shortened (it is relatively easy to program the memory cell). In other words, the erase time tERS may become longer.

When a shortened time period tPROG_Majority is below a reference value (time) Rtime (when a cycling number is 2), a controller 10 may generate a command to change an operational condition of a NAND flash memory 20. The N % pass time period tPROG_Majority may be recovered up to an original time (a time period tPROG_Majority before a cycling number N1) by changing an operational condition of the NAND flash memory 20. Although the time period tPROG_Majority is recovered by changing an operational condition with respect to the cycling number of 2, it may be shortened due to iteration of cycling later.

When a shortened time period tPROG_Majority is below the reference value (time) Rtime (when a cycling number is 3), the controller 10 may generate a command to change an operational condition of the NAND flash memory 20. The time period tPROG_Majority may be again recovered up to an original time by changing an operational condition of the NAND flash memory 20. As described above, the controller 10 may monitor a signal of the flag F_Majority to determine a time period tPROG_Majority. Whenever the time period tPROG_Majority is determined to be below the reference value, the controller 10 may change an operational condition of the NAND flash memory 20.

To change an operational condition of the NAND flash memory 20, a condition table 11 of the controller 10 may store a reference value of the time period tPROG_Majority, the number by which the time period tPROG_Majority is determined to be below a reference value, and an operational condition to be applied to a block at a next operation.

FIG. 6 is a diagram illustrating a condition table according to an embodiment of the inventive concept. A table illustrated in FIG. 6 shows the number of correction and operational conditions (operational conditions at reading, programming, program verifying, and erasing) of a NAND flash memory 20 corresponding to the number of correction. In the table, a voltage Vread may indicate an initial voltage of an unselected word line at reading. A voltage Vpgm may indicate an initial voltage at programming. A voltage Vpass may indicate an initial voltage of an unselected word line at program verifying. A voltage Vsel may indicate an initial voltage of a selected word line. A voltage Vers may indicate an erase voltage (or an initial voltage) at erasing. A reference time Rtime of a time period tPROG_Majority may be 150 μs.

As understood from FIG. 6, when an N % pass time period tPROG_Majority (in detail, a time period elapsed from a program start until a time when a flag F_Majority is output) is first shorter than the reference value (150 μs) (when a cycling number of FIG. 5 is N2), first correction on an operational condition may be performed. At the first correction, the unselected word line voltage Vread may be increased from the initial voltage Vread by 0.1V (Vread1=Vread+0.1 V). In other words, a program speed may become faster due to deterioration of an oxide film of a flash memory (a program voltage may be lowered), so that a memory cell is capable of being over-programmed (a minimum threshold voltage Vt causing a reaction may increase). For this reason, the voltage Vread to be applied to an unselected word line may be increased.

At the first correction, the initial voltage Vipgm at programming may be set to Vipgm by decreasing it by 0.1V (Vipgm=Vipgm−0.1 V). A program speed may become faster due to deterioration of an oxide film of a flash memory. The program voltage may be decreased to prevent a memory cell from being over-programmed.

At the first correction, a step voltage Vstep1 in an ISPP cycle may maintain the initial voltage Vstep (Vstep1=Vstep). The ISPP may be a write manner in which a voltage to be applied to a gate of a memory cell increases stepwise. In the ISPP manner of the NAND flash memory 20, writing of data to a selected memory cell may be performed over stepwise increasing a program voltage every loop.

At the first correction, a voltage Vpass of an unselected word line at program verifying may be increased by 0.1V from the initial voltage Vpass (Vpass1=Vpass+0.1V). This may be because a minimum threshold voltage Vt causing a reaction is lowered by deterioration of an oxide film of a flash memory. On the other hand, a voltage Vpass of an unselected word line at program verifying may be increased to cope with the phenomenon. The voltage Vsel at program verifying may be increased by 0.1V from the initial voltage Vsel (Vsel1=Vsel+0.1 V), and a voltage Vers1 at erasing may maintain the initial voltage Vers (Vers1=Vers). In example embodiments, a voltage Vers1 at erasing may be the initial voltage Vers. However, the voltage Vers1 can be increased in view of the probability that a memory cell is over-programmed.

When the time period tPROG_Majority is again shorter than the reference time (150 μs) (when a cycling number of FIG. 5 is N3), a second correction on the operation condition may be performed. At the second correction, the voltage Vread of the unselected word line at reading may be increased by 0.2V from the initial voltage Vread (Vread2=Vread+0.2V). The program voltage Vipgm may be decreased by 1.5V from the initial voltage Vipgm (Vipgm2=Vipgm−1.5V). A step voltage Vstep in an ISPP cycle may be decreased by 0.1V from the initial voltage Vstep (Vstep2=Vstep−0.1V).

At the second correction, a voltage Vpass of an unselected word line at program verifying may be increased by 0.2V from the initial voltage Vpass (Vpass2=Vpass+0.2V). The voltage Vsel at program verifying may be increased by 0.1V from the initial voltage Vsel (Vsel2=Vsel+0.1V), and a voltage Vers2 at erasing may maintain the initial voltage Vers (Vers2=Vers).

Whenever the time period tPROG_Majority is determined to be below a reference value, the controller may sequentially perform third correction, fourth correction, and so on according the same manner as described above.

As described above, a non-volatile semiconductor memory device 1 using a NAND flash memory 20 may monitor a time period tPROG_Majority when a flag F_Majority is output from the flash memory 20. If the time period tPROG_Majority is determined to be below a reference value, a controller 10 may store a block address and the number (correction number) by which the time period tPROG_Majority is determined to be below a reference value, at a block address storage block 12 (1 at first correction, 2 at second correction, 3 at third correction, etc.).

In the case where a block of a block address stored at the block address storage block 12 is accessed, the controller 10 may refer to a condition table 11 on the basis of the number of correction of a corresponding block stored at the block address storage block 12. The controller 10 may read an operational condition corresponding to the number of correction to configure the NAND flash memory 20 with the read operational condition. Afterwards, a required operation (a read/program/erase operation) may be executed.

Values in the condition table of FIG. 6 may be determined by test data. The condition table of FIG. 6 may be exemplary. Values in the condition table of FIG. 6 can be changed according to a type or configuration of a non-volatile semiconductor memory device. In the case where the number of correction on any block increases (a characteristic is deteriorated), a corresponding block can be set to an unusable block. In this case, it is possible to extend a life of the NAND flash memory 20 and to improve the reliability of the NAND flash memory 20.

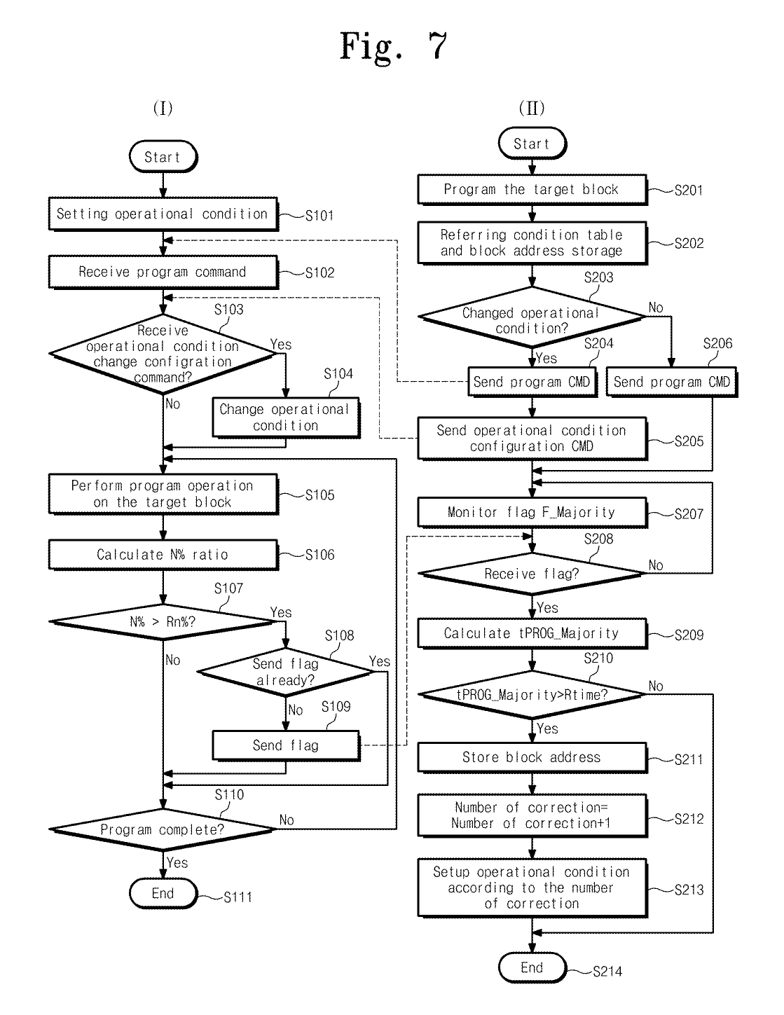

FIG. 7 is a flow chart illustrating an operation of a non-volatile semiconductor memory device according to an embodiment of the inventive concept. FIG. 7(I) shows a process flow at a program operation of a NAND flash memory 20, and FIG. 7(II) shows a process flow of a controller at a program operation.

First, an operation of the NAND flash memory 20 will be described referring to a flow chart illustrated in to FIG. 7(I). It is assumed that an operational condition of the NAND flash memory 20 is configured to an initial state (S101). In the case where the NAND flash memory 20 receives a program execution command on a block of a memory cell array 21 from a controller 10 (S102), whether an operational condition change configuration command is received with the program execution command may be determined (S103). If the operational condition change configuration command is not received (NO), the NAND flash memory 20 may execute a program operation on a program target block without a change of an operational condition on the memory cell array 21.

If the operational condition change configuration command is not received (Yes), an operational condition on the memory cell array 21 may be changed by an operational condition change configuration block 32 based on operational condition data included in the operational condition change configuration command (S104). Afterward, the flow proceeds to operation S105, in which a program operation on a corresponding block is executed under a condition that an operational condition on the memory cell array 21 is changed.

At a program verify operation of each cycle of ISPP of the NAND flash memory 20, an N % ratio (a program bit rate) may be calculated by a fail bit counter 37 and a program bit rate calculator 36 (S106). The NAND flash memory 20 may determine whether the N % ratio exceeds a predetermined ratio Rn % (e.g., 70%) (S107). If the N % ratio does not exceed the predetermined ratio Rn % (No), the NAND flash memory 20 may determine whether a program operation of a program target block is completed (S110).

If the N % ratio exceeds the predetermined ratio Rn % (Yes), the NAND flash memory 20 may determine whether a transfer of a flag F_Majority to the controller 10 is completed (S108). If a transfer of a flag F_Majority to the controller 10 is determined to be completed (Yes), the NAND flash memory 20 may determine whether a program operation of a program target block is completed (S110). If a transfer of a flag F_Majority to the controller 10 is determined not to be completed (No), the NAND flash memory 20 may send the flag F_Majority to the controller 10. Afterwards, the method proceeds to operation S110.

In operation S110, whether a program operation of a program target block is completed may be determined. If a program operation of the program target block is determined to be completed (Yes), the method proceeds to operation S111 to terminate the program operation. If a program operation of the program target block is determined not to be completed (No), the method proceeds to operation S105 to perform the program operation.

Referring to FIG. 7(II), a process flow of the controller 10 at a program operation will be described. Referring to a flow chart illustrated in FIG. 7(II), if a program operation of a program target block of the flash memory 20 commences (S201), the controller 10 may determine whether to change an operational condition of the NAND flash memory 20 on a corresponding block (S203). In the case where a block address of the program target block is stored at a block address storage block 12, the controller 10 may determine an operational condition of the NAND flash memory 20 to be changed. At this time, the controller 10 may read the number of correction on the block. The controller 10 may extract an operational condition corresponding to the number of correction from a condition table 11.

In the case where an operational condition of the NAND flash memory 20 is determined to be changed (Yes in operation S203), the controller 10 may send a program execution command to the NAND flash memory 20 (S204), and then may send an operational condition change configuration command (S205). In the case where an operational condition of the NAND flash memory 20 is determined not to be changed (No in operation S203), the controller 10 may send the program execution command to the NAND flash memory 20 (S206).

If a program operation of the NAND flash memory 20 commences, the controller 10 may monitor a flag F_Majority output from the NAND flash memory 20 (S207). The controller 10 may determine whether to receive the flag F_Majority from the NAND flash memory 20 via monitoring (S208). The controller 10 may continue to monitor the flag F_Majority during a program execution period of the NAND flash memory 20.

In the case where the flag F_Majority is received from the NAND flash memory 20 (Yes in operation S208), the method proceeds to operation 5209, in which the controller 10 calculates a time period tPROG_Majority from a program start until a time when the flag F_Majority is received. Afterward, the controller 10 may determine whether the time period tPROG_Majority is shorter than a reference time Rtime (S210).

If the time period tPROG_Majority is longer than a reference time Rtime (No), the method may be terminated (S214).

If the time period tPROG_Majority is shorter than a reference time Rtime (Yes), the controller 10 may store a block address of a corresponding block at a block address storage block 12 (S211). The controller 10 may increase the number of correction corresponding to a corresponding block address by one to store it at the block address storage block 12 (S212). The controller 10 may configure an operational condition of the same NAND flash memory 20 according to the number of correction on a corresponding block (S213). Afterwards, the method may be terminated (S214).

As described above, the controller 10 may monitor a flag F_Majority output when N % (N being any number of 1 to 10) of cells to be programmed is passed at program verifying, to determine a time period tPROG_Majority. The controller 10 may maintain an operational condition to be applied to the NAND flash memory 20 at a condition table 11 according to a reference value of the time period tPROG_Majority and the number (correction number) by which the time period tPROG_Majority is determined to be below the reference time.

In the case where a time period tPROG_Majority of a program target block is below the reference value, the non-volatile semiconductor memory device 1 may store a block address of the block at a block address storage block 12 with the number (correction number). When the block is next accessed, the NAND flash memory 20 may be requested to apply a new operational condition according to the number of correction referring to the condition table 11.

Since there is no need to store a cycling number of each block at the NAND flash memory, a register region may be reduced. It is possible to manage each block according to a characteristic deterioration state. Thus, in comparison with a case that an operational condition of the NAND flash memory 20 is changed using an average cycling number, deterioration of a characteristic of the NAND flash memory 20 may be reduced. It is possible to improve the reliability of the NAND flash memory 20.

In another embodiment, a non-volatile semiconductor memory device may include a write-dedicated area of all ‘0’ (all data being zero) every block. a non-volatile semiconductor memory device 1A using a NAND flash memory 20A may monitor a flag F_Majority (N % pass information) output when N % (N being any number of 1 to 100) of memory cells in a write-dedicated area of a program target block is passed at program verifying. An N % pass time (tPROG_Majority)_Majority (a time period elapsed from a program start of a write-dedicated area until an output time of the flag F_Majority) may be determined by monitoring the flag F_Majority (N % pass information). The non-volatile semiconductor memory device may store and retain an operational condition to be next applied to a NAND flash memory when a time period tPROG_Majority is below a reference value of the N % pass time period tPROG_Majority.

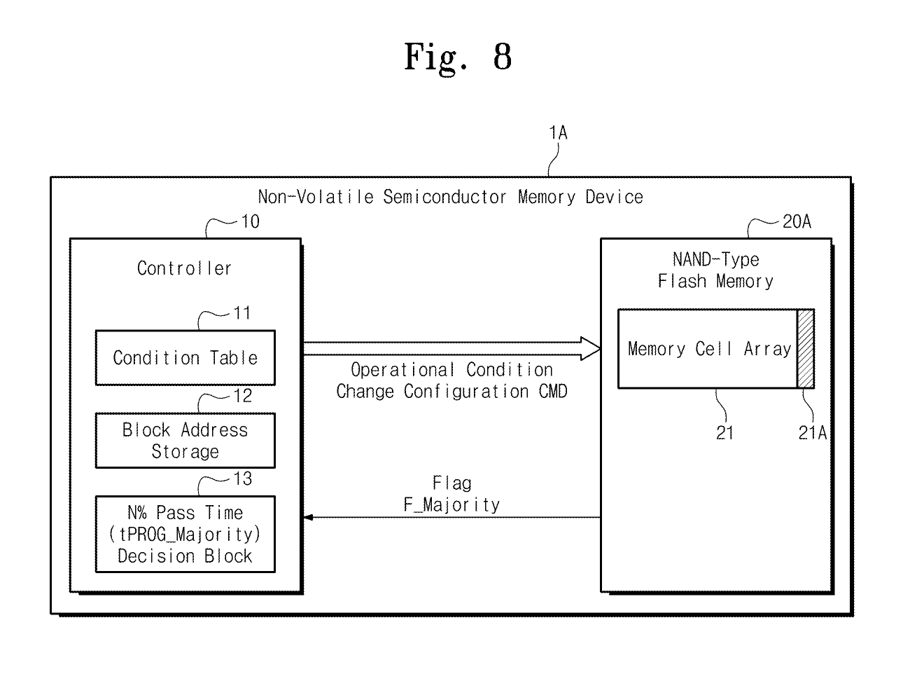

FIG. 8 is a block diagram schematically illustrating a non-volatile semiconductor memory device according to another embodiment of the inventive concept. In FIG. 8, components that are the same as those of FIG. 1 are identified by the same reference numerals, and a description thereof is omitted here to avoid redundancy. The non-volatile semiconductor memory device 1A of this example includes a NAND flash memory 20A and a controller 10 to control the NAND flash memory 20A. Here, the controller 10 may be the same as that described in connection with FIG. 1, while the NAND flash memory 20A may differ from the NAND flash memory 20 of FIG. 1 in that the memory cell array 21 of the flash memory 20A is equipped with a write-dedicated area 21A. The write-dedicated area 21A, which may store a logic bit ‘0’ in the memory cells thereof, is described in greater detail below.

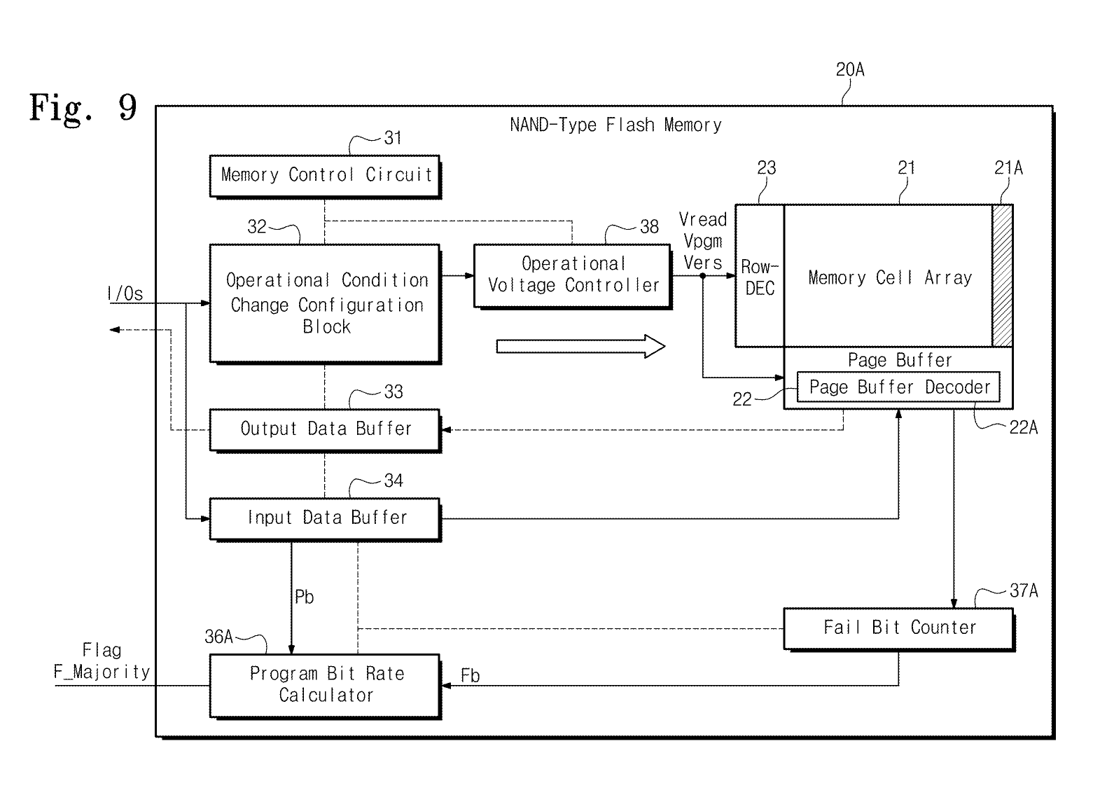

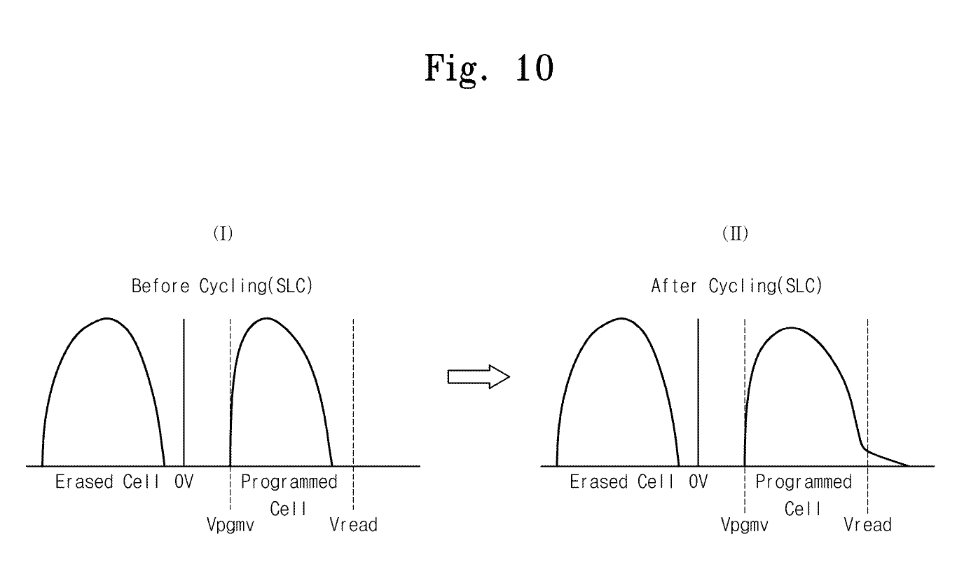

FIG. 9 is a block diagram schematically illustrating a NAND flash memory 2A shown in FIG. 8 according to another embodiment of the inventive concept. In FIG. 9, components that are the same as those of FIG. 2 are identified by the same reference numerals, and a description thereof is thus omitted here to avoid redundancy. A NAND flash memory 20A of flash memory 204 of this example includes a memory cell array 21, a write-dedicated area 21A included in the memory cell array 21, a page buffer 22 including a page buffer decoder 22A, and a row decoder 23. The NAND flash memory 20A may further include a memory control circuit 31 to control an overall operation of the NAND flash memory 20A, an operational condition change configuration block 32, an output data buffer 33, an input data buffer 34, a program bit rate calculator 36A, a fail bit counter 37A, and an operational voltage controller 38.

As mentioned above, the memory cell array 21 of FIG. 9 includes the write-dedicated area 21A. The write-dedicated area 21A is illustrated to be collectively formed at one location. However, a write-dedicated area of all ‘0’ data may be provided at each block being a program unit (e.g., a data write unit). Deterioration of a characteristic of each block may be monitored by writing data at the write-dedicated area 21A and erasing it. If all ‘0’ data is written at the write-dedicated area 21A, deterioration of a characteristic of each block may be determined to be a worst condition.

The fail bit counter 37A may count the number of memory cells (hereinafter, referred to as a fail cell number) in the write-dedicated area 21A determined as fail cells at a verify read operation, and may provide the counted fail cell number Fb to the program bit rate calculator 36A. The program bit rate calculator 36A may calculate a program bit rate (%) based on the fail cell number Fb from the fail bit counter 37A and the number Pb (a predetermined bit number) of ‘0’ bits written at the write-dedicated area 21A. The program bit rate calculator 36A may output a flag F_Majority to a controller 10 when the program bit rate (a ratio of memory cells passed at program verifying) exceeds a predetermined ratio (e.g., 70%).

In the NAND flash memory 20A, charges may be trapped by an oxide film of a memory cell according to iteration of cycling, so that a program time of the memory cell becomes faster (it is relatively easy to program the memory cell). However, In the case where a plurality of bits is simultaneously programmed at memory cells in the NAND flash memory 20A, a bit having a slow program speed (or, a long program time) may surely exist. Thus, it is difficult to express a whole program time as a sum tPROG of program times.

The write-dedicated area 20A of all ‘0’ may be prepared at the NAND flash memory 20A to prevent a variation in a most program time from being unknown due to a low-speed bit (having a long program time). The NAND flash memory 20A may count a program fail bit number of the write-dedicated area 21A to output the flag F_Majority to an external device when N % (N being any number of 1 to 100) of memory cells in the write-dedicated area 21A is passed at program verifying. The NAND flash memory 20A may have a function of changing an operational condition in response to a request of the external device.

A non-volatile semiconductor memory device 1A may monitor a time period tPROG_Majority of the write-dedicated area 21A being a program target like a non-volatile semiconductor memory device 1 described with reference to FIGS. 4 to 6. If the time period tPROG_Majority is below a reference value, the non-volatile semiconductor memory device 1A may store a block address and the number (or, correction number) by which the time period tPROG_Majority on a corresponding block is determined to be below the reference value, at a block address storage block 12 (1 at first correction, 2 at second correction, 3 at third correction, etc.).

In case of accessing a block of which the address is stored at the block address storage block 12, the controller 10 may refer to a condition table 11 based on a correction number of a corresponding block stored at the block address storage block 12. The controller 10 may configure the NAND flash memory 20A with the read operational condition, and then may perform a given operation (a read/program/erase operation).

A process flow of a program operation of a NAND flash memory 20 illustrated in FIG. 7(I) may be also applied to a process flow of a program operation of the NAND flash memory 20A. In this case, operation S106 may be performed by the fail bit counter 37A and the program bit rate calculator 36A of the flash memory 20A.

The controller 10 may determine a time period tPROG_Majority by monitoring the flag F_Majority output when N % (N being any number of 1 to 100) of memory cells to be programmed in the write-dedicated area 21A is passed at program verifying. The controller 10 may store and retain an operational condition to be applied to the NAND flash memory 20A at the condition table 11 in response to a reference value of the time period tPROG_Majority and the number (or, correction number) by which the time period tPROG_Majority is determined to be below the reference value.

In the case where a time period tPROG_Majority of a program target block is below the reference value, a block address of the program target block and the number (or, correction number) may be stored at the block address storage block 12. In the case where an access to the block is performed later, the NAND flash memory 20A may be requested to apply a new operational condition corresponding to a correction number referring to the condition table 11.

Since there is no need to store a cycling number of each block at the NAND flash memory 20A, a register region may be reduced. It is possible to manage each block according to a characteristic deterioration state. Thus, in comparison with a case that an operational condition of the NAND flash memory 20A is changed using an average cycling number, deterioration of a characteristic of the NAND flash memory may be reduced. It is possible to improve the reliability of the NAND flash memory 20A.

Herein, a non-volatile semiconductor memory device may correspond to a non-volatile semiconductor memory device 1 illustrated in FIG. 1, and a flash memory may correspond to a NAND flash memory device 20. A control block of the inventive concept may correspond to a controller 10 illustrated in FIG. 1, and a condition table of the inventive concept may correspond to a condition table 11. A block address storage block of the inventive concept may correspond to a block address storage block 12, and an N % pass time decision block may correspond to an N % pass time (tPROG_Majority) decision block 13. N % pass information of the inventive concept may correspond to a flag F_Majority output from the NAND flash memory 20. A first time of the inventive concept may correspond to a time period tPROG_Majority, and a second (reference) time of the inventive concept may correspond to a reference value.

In example embodiments, when a block of a flash memory 20 is programmed, a non-volatile semiconductor memory device 1 may have a function of calculating a first time period tPROG_Majority until programming of N % of memory cells to be programmed in the block is completed, a function of comparing the first time period tPROG_Majority with a second time being a reference value, and a function of changing an operational condition of the flash memory 20 at a next access to the block when the first time period tPROG_Majority of the block is below the second and accessing the block according to the changed operational condition.

The non-volatile semiconductor memory device 1 may calculate the first time period tPROG_Majority when N % of memory cells to be programmed in a program target block is passed at program verifying, store a block address of a corresponding block when the time period tPROG_Majority is below a reference value, and change an operational condition of the flash memory 20 only on the block at a next access to the block. In this case, it is possible to detect a characteristic deterioration state on a memory cell every block of the flash memory. It is a need to configure an operational condition of the flash memory according to a deterioration state of each block. A general operational condition may be used with respect to a block in which memory cells are not deteriorated. It is possible to set a deteriorated block (having a high deterioration level) to be an unusable block. Thus, it is possible to extend a life of a flash memory without causing deterioration of a characteristic of the flash memory. Also, it is possible to improve the reliability of the flash memory.

Also, the non-volatile semiconductor memory device 1 may include a control block (e.g., a controller 10) to control an operation of a flash memory 20 as a NAND flash memory 20 having a memory area in which memory cells are arranged in an array shape. The flash memory 20 may include a control block (e.g., a controller 10) which has a function of outputting to an external device (e.g., a controller 10) N % pass information (a flag F_Majority), indicating that N % of memory cells is passed at program verifying, when N % (N being any number of 1 to 100) of memory cells to be programmed in a program target block is passed at program verifying and a function of changing an operational condition of a corresponding flash memory 20 in response to a request from the external device (e.g., a controller 11). The control block (e.g., a controller 10) may include a function of deciding a first time period tPROG_Majority from a program state of a program target block until N % of memory cells is passed at program verifying, a function of comparing the first time period tPROG_Majority and a second time, and a function of storing an block address of a corresponding block when the first time of the program target block is below the second time and simultaneously requesting the flash memory 20 to change an operational operation of the flash memory 20 to a predetermined operational condition at a next access to the corresponding block.

In the non-volatile semiconductor memory device 1, the flash memory 20 may output N % pass information (a flag F_Majority) to an external device (e.g., a controller 10) when N % of memory cells in a program target block is programmed. The flash memory 20 may change an operational condition in response to a request from the external device (e.g., a controller 10). A control block (e.g., a controller 10) may monitor N % pass information (a flag F_Majority) output from the flash memory 20 to determine a first time period tPROG_Majority (from a program state until the flag F_Majority is output. The control block (e.g., a controller 10) may store a block address and an operational condition to be applied to a next access to a corresponding block when the time period tPROG_Majority is below the second time (e.g., a reference value). The control block may request the flash memory 20 to apply an operational condition at a next access to the block address. The operational condition may be an operational condition at a program/program verify/read/erase operation.

Thus, it is possible to detect deterioration of a characteristic of a memory cell in a flash memory without storing the number of cycling of each block and to configure an operational condition of the flash memory according a deterioration state of each block. Thus, it is possible to extend a life of the flash memory and to improve the reliability of the flash memory.

In example embodiments, the control block (e.g., a controller 10) may configure a flash memory 20 with another operational condition at a next access to a block whenever a first time period tPROG_Majority at execution of a program operation on the block is below a second time (e.g., a reference value).

After an operational condition of the flash memory on a block is changed into a first operational condition, the non-volatile semiconductor memory device 1 may change an operational condition of the flash memory on the block into a second operational condition when the first time period tPROG_Majority on the block is again determined to be below the second time (e.g., a reference value). Afterwards, the flash memory 20 may be configured with a predetermined (stored) operational condition corresponding to the number (or, correction number) whenever the first time period tPROG_Majority on the block is determined to be below the second time. In the case where deterioration of a characteristic of a memory cell in a block is in progress, it is possible to configure an operational condition according to a characteristic deterioration state of the memory in the block. Thus, it is possible to improve the reliability of the flash memory 20.

In example embodiments, the non-volatile semiconductor memory device 1 may include a control block (e.g., a controller 10) which includes an N % pass time decision block 13 which determines a first time period tPROG_Majority from a program start on a program target block until a time when N % pass information (e.g., a flag F_Majority) is output; a block address storage block 12 which stores a block address of a block and the number (or, correction number) by which the first time period tPROG_Majority on the program target block is determined to be below a second time, when the first time period tPROG_Majority on the program target block is determined to be below the second time; and a condition table 11 which stores and retains the correction number and an operational condition to be applied to the flash memory 20 according to the correction number. The control block (e.g., a controller 10) may refer to the condition table 11 and the block address storage block 12 before an access to a block in the flash memory 20. If a block address of a corresponding block is stored at the block address storage block 12, the control block (e.g., a controller 10) may extract an operational condition corresponding to the correction number of the corresponding block from the condition table 11. After configuring the flash memory 20 with the extracted operational condition, the control block (e.g., a controller 10) may access the corresponding block.

The non-volatile semiconductor memory device 1 may determine a first time period tPROG_Majority from a program start on a program target block until a time when N % pass information (e.g., a flag F_Majority) is output, to compare the first time period tPROG_Majority with a second time. In case of a block of which the first time period tPROG_Majority is determined to be below the second time, a block address of the block and the number (or, correction number) by which the first time period tPROG_Majority is determined to be below the second time may be stored at the block address storage block 12. The correction number and an operational conditional to be applied to the flash memory 20 according to the correction number may be stored and retained by the condition table 11. The control block (e.g., a controller 10) may refer to the condition table 11 of the block address storage block 12 before an access to a block in the flash memory 20. If a block address of a corresponding block is stored at the block address storage block 12, the control block (e.g., a controller 10) may extract an operational condition corresponding to the correction number of the corresponding block from the condition table 11. After configuring the flash memory 20 with the extracted operational condition, the control block (e.g., a controller 10) may access the corresponding block.

In the case where a characteristic of a memory cell in a block is deteriorated, it is possible to store and retain a block address of the block and to configure the flash memory 20 with an operational condition according to deterioration of a characteristic of the memory cell in the block.

In example embodiments, an operational condition changed at an access may be an operational condition associated with one or all of a program operation, a program verify operation, a read operation, and an erase operation. In the case where a characteristic of a memory cell in a block is deteriorated, it is possible to configure an operational condition at a program operation, a program verify operation, a read operation, or an erase operation according to a deterioration state of the memory cell.

In example embodiments, a write-dedicated area may correspond to a write-dedicated area 21A. The non-volatile semiconductor memory device 1A may determine a time period elapsed from a program start until a time when programming of N % of memory cells in the write-dedicated area 21A prepared at a block is completed.

In example embodiments, data programmed at the write-dedicated area 21A may be data written by injecting charges into a floating gate of a memory cell of a flash memory. It is possible to write data forcing the largest stress to a memory cell in the write-dedicated area 21A to determine deterioration of a memory block in a block. Thus, it is evaluate a deterioration state of a memory cell in a block using the worst condition.

The non-volatile semiconductor memory device of the inventive concept may not be limited to this disclosure. The non-volatile semiconductor memory device may be variously changed without departing from the spirit and scope of the present invention.

For example, the inventive concept is described under a condition that a flash memory is a NAND flash memory. However, the flash memory can be formed of a NOR flash memory. The inventive concept is not be limited to the specific above-described non-volatile semiconductor memory, and instead, the inventive concept may be effectively applied to a variety of systems including a flash memory.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A non-volatile semiconductor memory device, comprising:
a flash memory including plural blocks of memory cells;
a controller configured to program a block of memory cells of the flash memory, to determine a first time period elapsed in which a given percentage of memory cells of the block of memory cells are programmed, and to compare the first time period with a reference second time period; and
the flash memory and controller being further configured, based on a comparison result between the first time period and the reference time period, to change an operational parameter associated with the block of memory cells, the changed operational parameter being in effect during at a next operational access of the block of memory cells.

2. The non-volatile semiconductor memory of claim 1, wherein the operational parameter associated with the block of memory cells is changed when the first time period is less than the reference time period.

3. The non-volatile semiconductor memory of claim 1, wherein flash memory is responsive to a command received from the controller to change the operational parameter associated with the block of memory cells.

4. The non-volatile semiconductor memory device of claim 1, wherein the flash memory is configured to output a flag signal when a given percentage N % (where 0<N≦100) of the memory cells of the block are successfully programmed.

5. The non-volatile semiconductor memory device of claim 4, wherein the controller is configured to determine the first time period based on a time at which the flag signal is output by the flash memory.

6. The non-volatile semiconductor memory device of claim 1, wherein the controller includes a block address storage to store a block address of the block of memory cells when the first time period is less than the reference time period.

7. The non-volatile semiconductor memory device of claim 6, wherein, during the next operational access of the block of memory cells, the controller is configured issue a command to change the operational parameter associated with the block of memory cells when the block address is stored in the block address storage.

8. The non-volatile semiconductor memory device of claim 7, wherein the flash memory is responsive to the command to change the operational parameter associated with the block of memory cells

9. The non-volatile semiconductor memory device of claim 1, wherein the controller comprises:
a pass time decision unit which determines the first time period, and compares the first time period and the reference time period to determine a correction number of the block indicative of a difference between the first time period and the reference time period;
a block address storage block which stores a block address of the block of memory cells and the correction number of the block of memory cells; and
a condition table which stores a plurality of operational parameters in relation to respective correction numbers.

10. The non-volatile semiconductor memory of claim 9, wherein the controller is configured, during the next operational access of the block of memory cells, to determine an operational parameter stored in the condition table which corresponds to the correction number stored in the block address storage, and issue a command to the flash memory to change the operational parameter associated with the block of memory cells to the determined operational parameter.

11. The non-volatile semiconductor memory of claim 1, wherein the operational parameter is at least one of a read voltage, a read verify voltage, a program voltage, an erase voltage and a pass voltage.

12. The non-volatile semiconductor memory of claim 11, wherein the memory cells are NAND flash memory cells.

13. The non-volatile semiconductor memory device of claim 1, wherein the block of memory cells is a write-dedicated area of the flash memory in which a same data is programmed into each of the memory cells.

14. The non-volatile semiconductor memory device of claim 13, wherein data programmed in the write-dedicated area is data written by injecting charges into a floating gate of the memory cells of the block.

15. A method of operating a non-volatile semiconductor memory device, the non-volatile semiconductor memory device including a memory controller and a flash memory including plural blocks of memory cells, the method comprising:
programming a block of memory cells of the flash memory;
determining a first time period elapsed in which a given percentage of memory cells of the block of memory cells are programmed;
comparing the first time period with a reference second time period; and
based on a comparison result between the first time period and the reference time period, changing an operational parameter associated with the block of memory cells, the changed operational parameter being in effect during at a next operational access of the block of memory cells.

16. The method of claim 15, wherein the operational parameter associated with the block of memory cells is changed when the first time period is less than the reference time period.

17. The method of claim 15, further comprising issuing a command from the controller to the flash memory to change the operational parameter associated with the block of memory cells.

18. The method of claim 15, outputting a flag signal from the flash memory to the controller when a given percentage N % (where 0<N≦100) of the memory cells of the block are successfully programmed.

19. The method of claim 15, wherein the operational parameter is at least one of a read voltage, a read verify voltage, a program voltage, an erase voltage and a pass voltage.

20. The method of claim 19, wherein the memory cells are NAND flash memory cells.
